(19) United States
(12) Patent Application Publication
(10) Pub. No.: US 2024/0176624 A1
(43) Pub. Date: May 30, 2024

(54) COMPUTING DEVICES AND METHOD AND COMPUTING DEVICE FOR INITIALIZING A COMPUTING DEVICE

(71) Applicant: Intel Corporation, Santa Clara, CA (US)

(72) Inventors: Vincent ZIMMER, Issaquah, WA (US); Subrata BANIK, Bangalore KA (IN); Rajaram REGUPATHY, Bangalore, KA (IN); Salil MATHACHAN THOMAS, Bangalore (IN)

(21) Appl. No.: 18/553,213

(22) PCT Filed: Apr. 1, 2022
(86) PCT No.: PCT/US22/71491

§ 371 Date: Sep. 29, 2023

(30) Foreign Application Priority Data
Jun. 23, 2021 (IN) 202141028125

(51) Int. Cl. G06F 9/4401; G06F 9/455; G06F 13/42

(52) U.S. Cl. CPC G06F 9/4403; G06F 9/45504; G06F 13/4282

(57) ABSTRACT

Various examples of the present disclosure relate to a computing device, and to a method and computer program for initializing a computing device. The computing device comprises a memory device, configured to store firmware for at least a first processing unit and a second processing unit. The computing device comprises a first processing unit, configured to obtain the firmware for the first processing unit from the memory device, and to initialize itself using the firmware obtained from the memory device. The computing device comprises a second processing unit, configured to obtain the firmware for the second processing unit from the memory device, and to initialize itself using the firmware obtained from the memory device.

### BACKGROUND

To meet a growing customer demand for having powerful client systems with exceptional visual experience, device manufacturers (such as OEMs, Original Equipment Manufacturers) may consider equipping computing devices, such as laptop computers, with discrete graphics for an improved visual experience, e.g., to achieve a great gaming experience, upgraded 3D performance, and/or latest media/display capabilities (possibly with the same form factor), even at an entry segment of the client market.

### BRIEF DESCRIPTION OF THE FIGURES

Some examples of apparatuses and/or methods will be described in the following by way of example only, and with reference to the accompanying figures, in which:

FIGS. 1a and 1b show block diagrams of examples of a computing device;

FIG. 1c shows a flow chart of an example of a method for initializing a computing device;

FIGS. 2a and 2b show a schematic drawing of a platform design with discrete graphics;

FIG. 3 shows a schematic diagram of a Discrete Graphics solution that is soldered down to a motherboard of a laptop computer;

FIGS. 4a, 4b, and 4c illustrate the possibility of redundancy in platform design between host CPU and DG;

FIG. 5 shows a schematic diagram of an example of an architecture for firmware/software resource sharing;

FIG. 6 shows a schematic diagram of an example of a computer device comprising a GPU and a CPU, which use a shared SPI flash;

FIG. 7 shows a schematic diagram of another example of a computer device comprising a DGPU and a CPU;

FIG. 8 shows a table of memory regions of an IFWI layout;

FIG. 9 shows an example of a modified DG motherboard-down initialization flow;

FIG. 10 shows a table that illustrates region access control;

FIG. 11 shows the use of redundant firmware blobs for each heterogenous processor;

FIG. 12 shows an example of a modified firmware boot flow with a unified firmware;

FIG. 13 shows a flow chart of a unified FSP initialization flow with IGD and DGPU;

FIG. 14 illustrates an initialization flow, where the DGPU is initialized via coreboot; and

FIG. 15 illustrates an initialization flow, where the DGPU is initialized via FSP.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

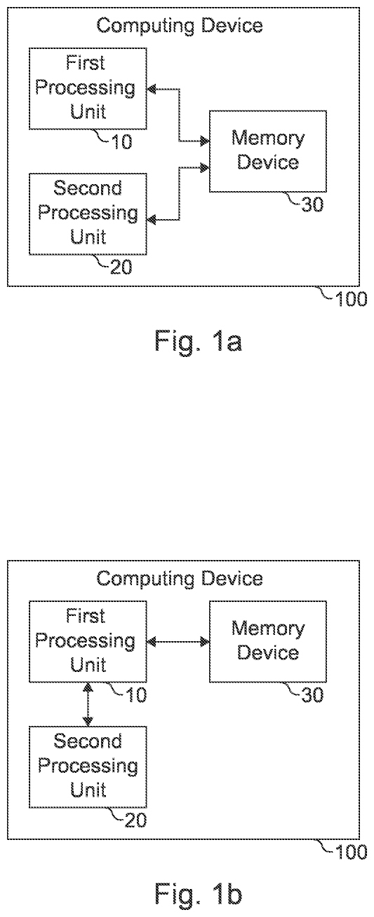

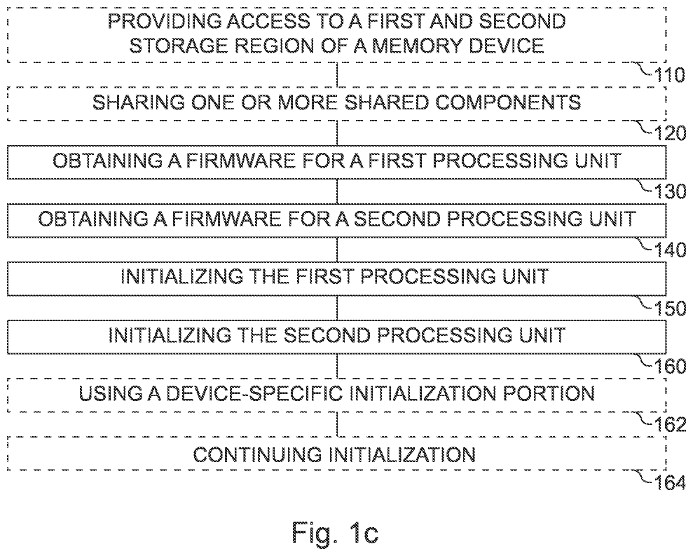

FIGS. 1a and 1b show block diagrams of examples of a computing device 100. The computing device 100 comprises a memory device 30 (or, more general, a means for storing information 30), configured to store firmware for at least a first processing unit and a second processing unit. The computing device 100 comprises the first processing unit 10 (or, more general, a first means for processing 10), configured to obtain the firmware for the first processing unit from the memory device, and to initialize itself using the firmware obtained from the memory device. The computing device 100 further comprises the second processing unit 20 (or, more general, a second means for processing), configured to obtain the firmware for the second processing unit from the memory device, and to initialize itself using the firmware obtained from the memory device. For example, the computing device 100 may comprise a circuit board, such as a motherboard, hosting the memory device 30, the first processing device 10 and the second processing device 20. For example, the memory device 30, the first processing device 10 and the second processing device 20 may be communicatively coupled via the circuit board.

FIG. 1c shows a flow chart of an example of a corresponding method for initializing the computing device. The method comprises obtaining 130 the firmware for the first processing unit from the memory device. The method comprises obtaining 140 the firmware for the second processing unit from the same memory device. The method comprises initializing 150 the first processing unit and initializing 160 the second processing unit using the respective firmware obtained from the memory device.

In the following, the proposed concept is illustrated with respect to the computing device 100. Features introduced in connection with the computing device may likewise be included in the corresponding method and in a corresponding computer program.

The present disclosure relates to the initialization of a computing device (i.e., a device or computer system). The computing device may be any kind of computing device comprising two or more separate processing units, such as a CPU (Central Processing Unit) and a discrete (i.e., separate from the CPU, not part of the same SoC) GPU (Graphics Processing Unit). For example, the first processing unit may be a CPU, and the second processing unit may be one of a (discrete) GPU, a Field-Programmable Gate Array (FPGA), a vision processing unit (VPU), and an Artificial Intelligence (AI) accelerator. In short, the processing units may be XPUs (X-Processing Units, with the “X” representing the different types of processing units introduced above). For example, the computing device may be an integrated computing device, e.g., a computing device where the memory device and the first and second processing units are soldered to the circuit board. For example, the computing device may be a laptop computer or a small form factor computer. For example, at least one of the first and the second processing unit may be a soldered-down processing unit. In particular, at least one of the first and the second processing unit may be soldered to the circuit board (e.g., motherboard) of the computing device. However, the concept is also applicable to computing devices, where at least one of the computing devices is removably coupled to the circuit board via a socket (e.g., the CPU) or a slot (e.g., the discrete GPU, via a Peripheral Component Interconnect express slot) or cable connection (e.g., Thunderbolt™).

The proposed concept is based on the insight, that the initialization of processing units in computing devices that comprise multiple processing units can be improved by removing the need for separate memory devices for each computing devices. In many systems, each processing device is coupled with a memory device, e.g., a NOR-based flash memory device that is accessible via a SPI (Serial Peripheral Interface), and thus called SPINOR, which holds the respective firmware being used to initialize the processing unit. In other words, the memory device may be a flash-based memory device that is configured to communicate with the first and second processing unit via the serial peripheral interface, SPI. For example, in many computing devices, a first memory device is coupled with the CPU, holding the BIOS firmware being loaded by the CPU. A separate second memory device is coupled with the GPU, holding the firmware being used to initialize the GPU. However, such a separation may be considered to be inefficient, as the memory device being coupled with the CPU often has enough free space for holding the GPU firmware (and/or other firmware blobs, such as a firmware of an AI accelerator or a firmware of an FPGA). In the proposed concept, the separate memory devices are consolidated, which may reduce the Bill of Materials (BOM) of the computing device. In addition, the proposed changes may be used to increase the security of the boot process, as the initialization of the processing units can be handled via the same security controller.

The proposed concept is thus based on sharing components of the computing device among the processing units. For example, the first and second processing unit may be configured to share one or more shared components of the computing device during a (secure) initialization procedure of the computing device. Accordingly, as further shown in FIG. 1c, the method comprises sharing 120, by the first and second processing unit one or more shared components of the computing device during a (secure) initialization procedure of the computing device.

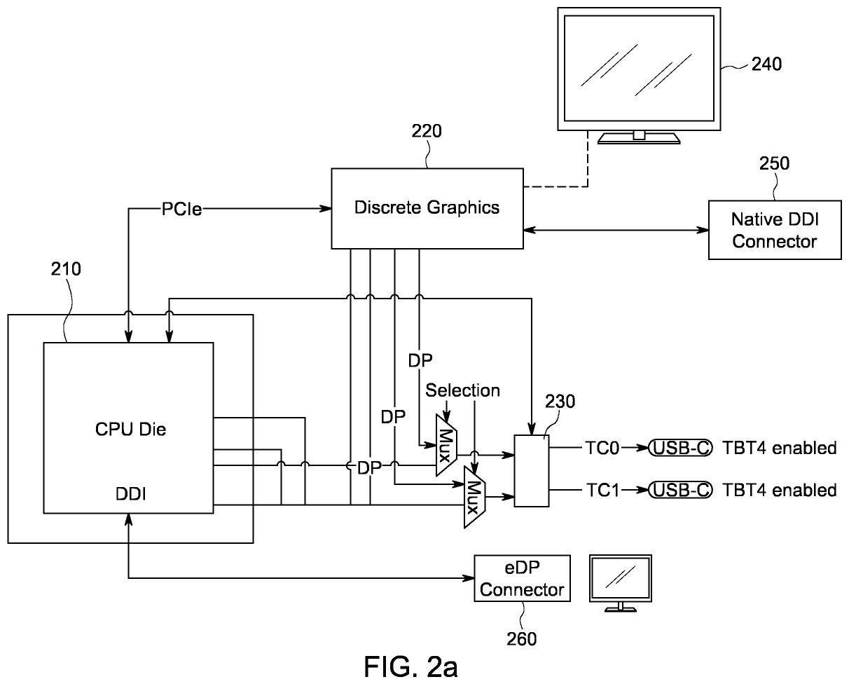

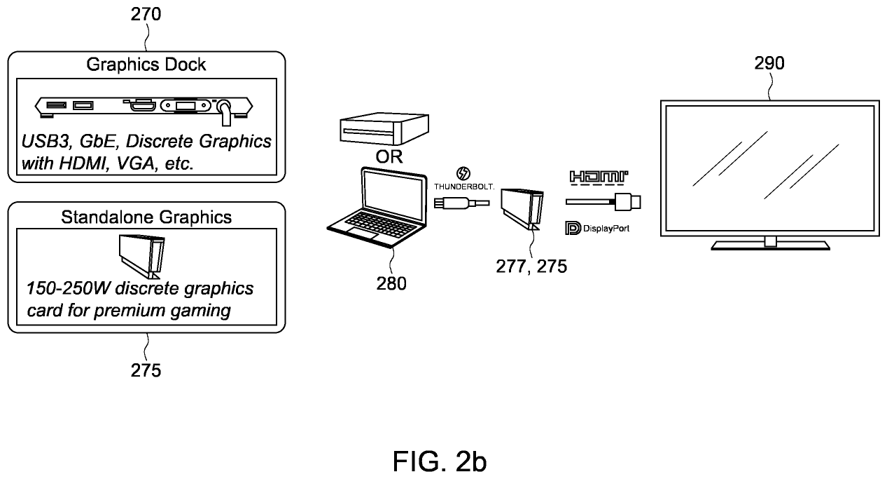

For example, as is evident, the one or more shared components comprise the memory device, as the memory device holds the firmware for both processing units. In addition, the one or more shared components may comprise at least one of (boot) security controller circuitry (or, more general, security controlling means) and flash controller circuitry (or, more general, flash controlling means). In connection with FIGS. 2 to 15, the sharing of the components is also referred to as “Phase #1”.

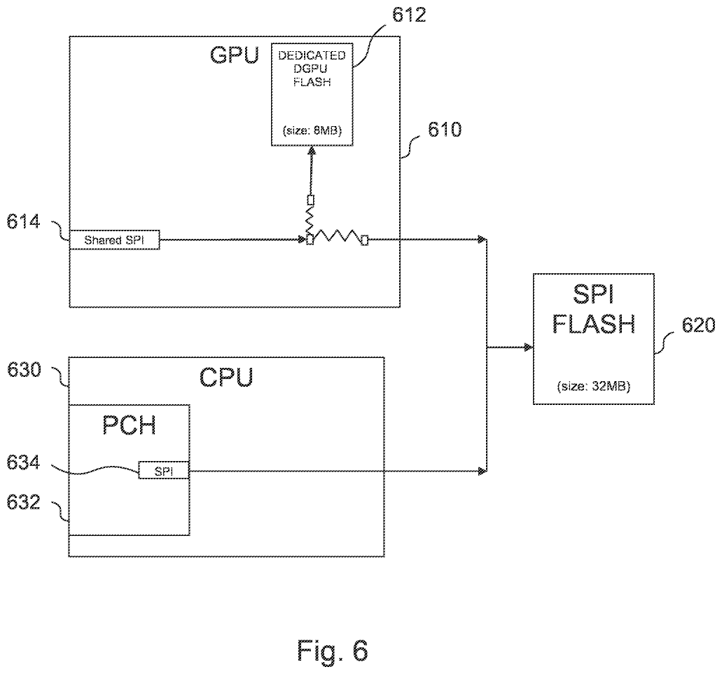

In FIG. 1a, an implementation is shown, where the memory device is directly accessible by the first and second processing unit, e.g., via the SPI. In this case, the memory device, and the flash controller circuitry (for controlling the memory device) may be shared among the first and second processing unit. A more detailed example of this configuration is shown in FIG. 6, where it is shown how both processing units (the CPU 630 and the GPU 610) access the SPI flash 620 (i.e., the memory device) via their respective SPI controllers 634; 614.

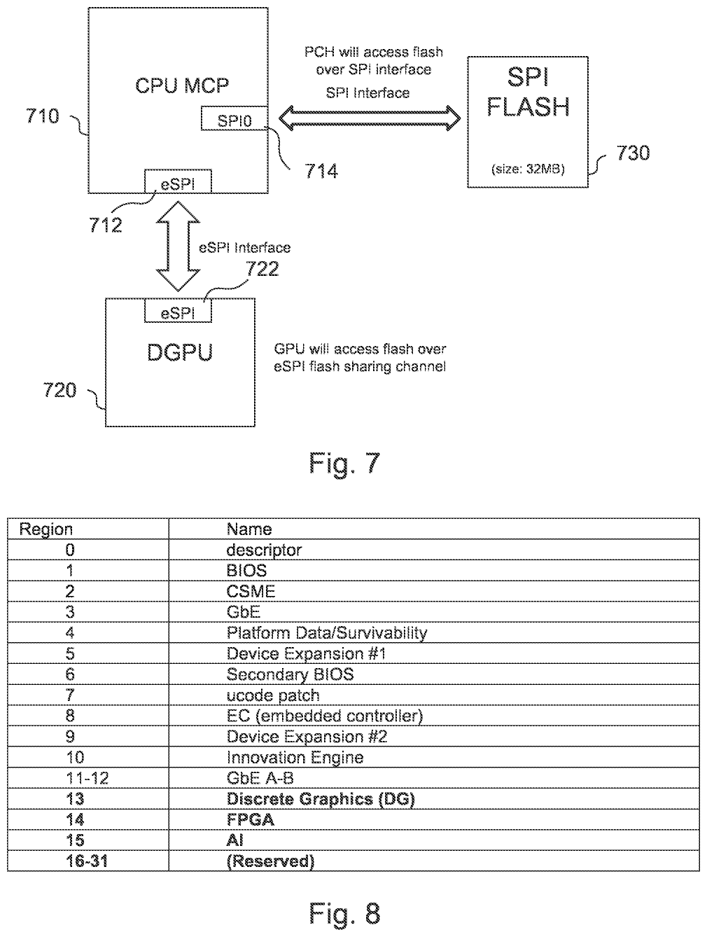

Alternatively, an access scheme named “Master-Attached-Flash” may be used, which is shown in FIG. 1b. In this access scheme, the memory device is coupled with a master processing unit (e.g., the first processing unit or CPU), with the slave processing unit (e.g., the second processing unit or GPU/FPGA/AI accelerator) accessing the memory device via the master processing unit. In other words, at least one of the first processing unit and the second processing unit may be configured to access the memory device via a master-attached flash sharing scheme. For example, as shown in FIG. 7, the CPU (i.e., the first processing unit) may directly communicate with the SPI flash via SPI, and the discrete GPU (i.e., the second processing unit) may communicate with the SPI flash via the CPU. For example, as shown in FIG. 7, the communication between the CPU and GPU may be via the enhanced Serial Peripheral Interface (eSPI).

In both configurations, the firmware for both processing units is stored in the same memory device, e.g., in the same die. In other words, the first and second processing unit may be configured to obtain the respective firmware from the same memory device. For example, the memory device may comprise a plurality of regions which each include firmware to boot, initialize, and/or operate an XPU (e.g., the first and second processing unit). For example, the memory device may comprise a first region, which includes the firmware for the first processing unit, and a second region, which includes the firmware for the second processing unit. In other words, the memory device may comprise a first storage region with the firmware for the first processing unit and a separate second storage region with the firmware for the second processing unit. Such an example is shown in FIG. 8, where region 1 comprises the BIOS, i.e., the firmware for the CPU (e.g., the first processing unit), region 13 comprises the firmware for the discrete GPU (e.g., the second processing unit), region 14 comprises the firmware for an FPGA (e.g., a third processing unit), region 15 comprises the firmware for an AI accelerator (e.g., a fourth processing unit) etc. As is evident from the description of FIG. 8, the memory device may be the memory device that is originally used for the CPU, which now additionally comprises the firmware of the other XPUs. In other words, the memory device may be a memory device associated with the first processing unit, with the memory device additionally comprising the separate second storage region with the firmware for the second processing unit. For example, the memory device may additionally comprise a separate third (and fourth) storage region comprising firmware for a third (and fourth) processing unit.

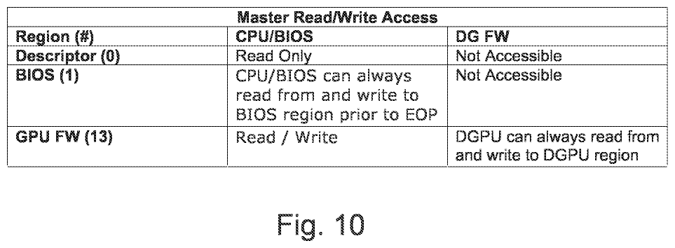

To strengthen the security of the proposed approach, region access control may be used to restrict access of the respective processing units to the regions of the memory device. The concept is illustrated in connection with FIG. 10, for example. For example, in general, the CPU (e.g., the first processing unit) may have access to (all of) the regions, while the other XPUs (e.g., the GPU, AI accelerator, FPGA) might only have access to “their” region, i.e., the region comprising the firmware of the respective processing unit. In other words, the memory device may be configured to provide access to the first and second storage region such, that access by the second processing unit is limited to the second storage region. Accordingly, as further shown in FIG. 1c, the memory device may provide 110 access to the first and second storage region such, that access by the second processing unit is limited to the second storage region.

As outlined above, the respective firmware stored by the memory device is used by the processing units to initialize themselves. For example, the first processing unit 10 is configured to obtain the firmware for the first processing unit from the memory device, and to initialize itself using the firmware obtained from the memory device, and the second processing unit 20 is configured to obtain the firmware for the second processing unit from the memory device, and to initialize itself using the firmware obtained from the memory device. For example, upon reset of the respective processing unit, the processing circuitry may be configured to fetch the firmware from the memory device (e.g., directly, or via the master processing unit, e.g., the CPU), and to execute the firmware to initialize the respective processing unit.

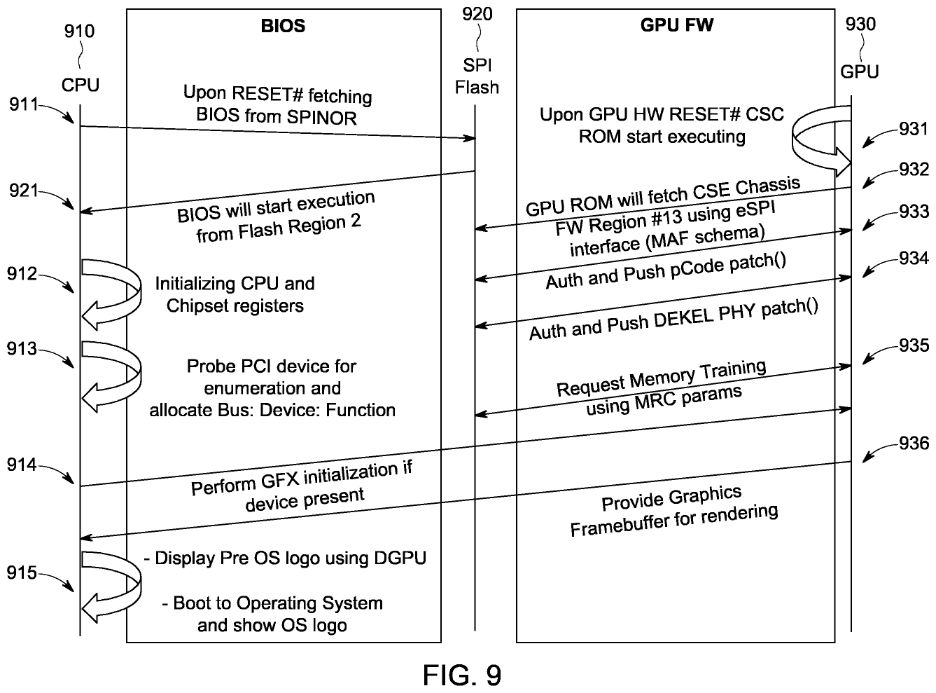

For example, the CPU may be configured to fetch the BIOS firmware, and to execute the BIOS firmware, the discrete GPU may be configured to fetch and execute the DGPU firmware etc. An example of a flow for a concurrent initialization of CPU and discrete GPU according to the proposed concept is shown in FIG. 9, for example.

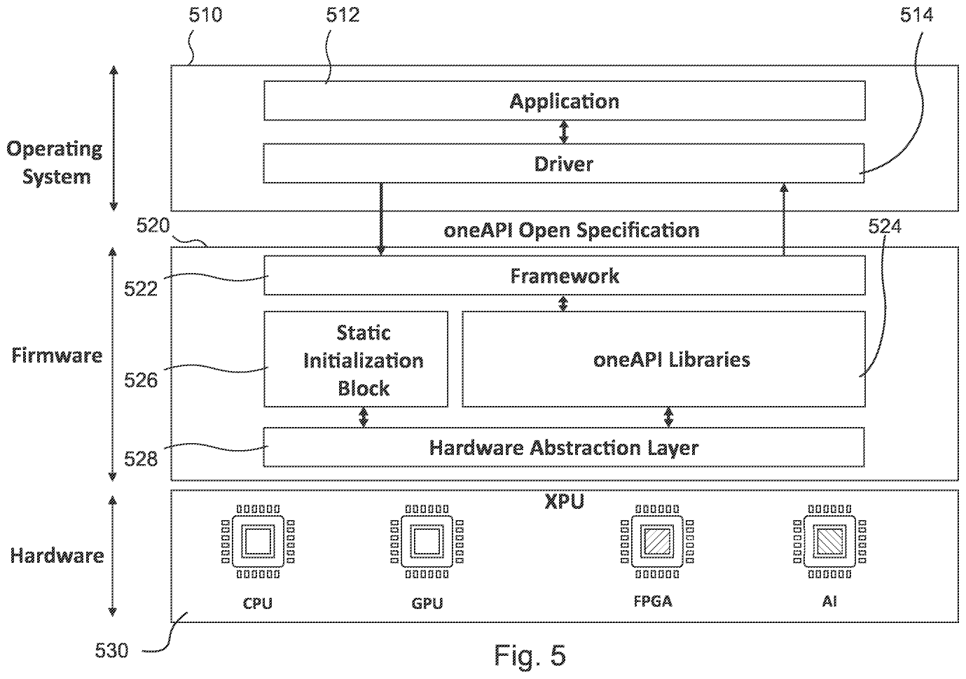

In the above examples, it is assumed that the respective processing units fetch the entire firmware of the respective processing unit from the respective (and separate) regions of the memory device. In some examples, however, a more integrated approach may be used, which may be denoted as “Phase #2” in connection with FIGS. 2 to 15. For example, as shown in FIG. 5, the firmware of the different XPUs may be unified, and separated into different components—a static initialization block 526 (which is used to perform basic initialization of the respective processing unit), a hardware abstraction layer 528 (which is used to translate device-agnostic instructions to device-specific instructions and device-specific callback values to device-agnostic callback values, one or more libraries 524 for exposing the functionality of the respective XPUs, and a framework 522 for accessing the libraries. In FIG. 5, the Intel® oneAPI framework is used to implement the firmware. For example, the firmware for at least the second processing unit (and, optionally, the first processing unit) may comprise a device-specific portion and a device-agnostic portion. For example, the device-agnostic portion (e.g., the one or more libraries 524) may be configured to access the respective processing unit via a hardware abstraction layer (e.g., hardware abstraction layer 528) being part of the device-specific portion. Moreover, the device-specific portion may comprise a device-specific static initialization portion (e.g., the static initialization block 526). Both the device-specific and device-agnostic portions may be stored in the memory device. For example, the memory device may comprise a shared region which includes codes for operating at least part of the first processing unit and at least part of the second processing unit (e.g., the device-agnostic portions).

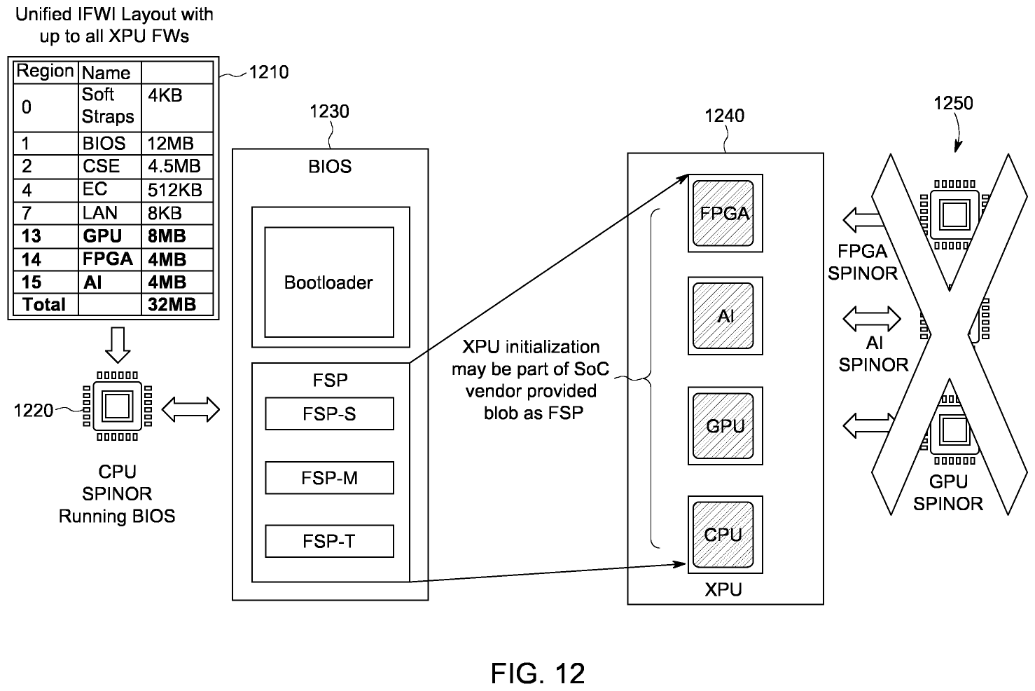

In connection with FIGS. 12, 13 and 15, example of implementations of such a scheme are shown. In these examples, the FSP (Firmware Support Package), and in particular the FSP-S (FSP-Silicon), is used to perform a joint implementation of the respective XPU. As outlined above, a device-specific static initialization portion may be used to initialize the respective XPU to a point where the XPU communicates with the CPU (and thus the FSP-S). From this point on, the initialization may be performed jointly with the FSP. For example, the second processing unit may be configured to use the device-specific static initialization portion to initialize itself to the point of communication with the first processing unit, and to continue initialization using the device-agnostic portion with help of the first processing unit. Accordingly, as further shown in FIG. 1c, the method may comprise, by the second processing unit, using 162 the device-specific static initialization portion to initialize itself to the point of communication with the first processing unit, and continuing 164 initialization using the device-agnostic portion with help of the first processing unit.

For example, the first and second processing units 10; 20 may each be implemented using one or more processing units, one or more processing devices, any means for processing, such as a processor, a computer or a programmable hardware component being operable with accordingly adapted software. For example, the first and second (and third) processing unit 10; 20 may each comprising processing circuitry, configured to provide the functionality of the respective processing unit.

In general, the memory device may comprise non-volatile storage for storing the firmware. For example, the memory device 30 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the computing device, method and computer program are mentioned in connection with the proposed concept, or one or more examples described above or below (e.g., FIGS. 2 to 15). The computing device, method and computer program may comprise one or more additional optional features corresponding to one or more aspects of the proposed concept, or one or more examples described above or below.

Various examples of the present disclosure relate to a method, system, and apparatus for Discrete Graphics (DG) symbiotic boot, which may use as library, such as the Intel® using OneAPI library, for in-field firmware update and verified boot.

Computer components, such as (heterogeneous) processors and/or other computer components may use firmware for booting, initialization, and/or operation. It may be desirable to provide computer components and computers (i.e., computing devices) with multiple processing capabilities, such as graphics and/or artificial intelligence. It may also be desirable to reduce the bill of materials (BOM) and/or cost.

Herein are disclosed methods and apparatuses that may allow sharing of resources between processors (i.e., processing units), such as CPUs (Central Processing Units), GPUs (Graphics Processing Units), AI (Artificial Intelligence) chips, FPGAs (Field-Programmable Gate Arrays), ASICs (Application-Specific Integrated Circuits), and microcontrollers (e.g., embedded microcontrollers). Identifying the common and/or sharable resources between CPU and other processors in a heterogeneous processor platform (such as a platform/computing device including a CPU and discrete graphics) may reduce dedicated hardware usage at the platform. Reducing hardware may help to reduce BoM cost, for example. The disclosed methods and apparatuses may improve efficiency such as by reusing firmware and/or software, e.g., by using OneAPI library.

Examples of discrete graphics solutions are (1) a discrete PCIe (Peripheral Component Interconnect express) based add-in-card (AIC), attached to PCIE slot in client device, (2) an external graphics connected via Thunderbolt (TBT) cable/port in the host PC (Personal Computer) and (3) a motherboard-down (MB-down) solution where the GPU is integrated into the motherboard as a companion element of the host system. FIGS. 2a and 2b show a schematic drawing of a platform design with discrete graphics. In FIG. 2a, a computing device with a CPU 210 with an integrated graphics card 220 (e.g., PCIe or MB-down) is shown. In FIG. 2a, the CPU 210 is capable of supplying a display signal (e.g., Display Port signal) via an integrated graphics solution (i.e., on-processor graphics). For example, multiplexers may be used to multiplex the DP signals of the discrete graphics 220 with the DP signals of the integrated graphics card, so that the DP signals can be output by a Thunderbolt controller 230 that is connected to Thunderbolt-enabled Universal Serial Bus (USB)-C interface. Alternatively, the discrete graphics card can output the images directly to a display 240 or native DDI (Display Driver Interface) connector 250. The integrated graphics of the CPU 210 may also be provided via an embedded Display Port (eDP) connector 260 to a display. In FIG. 2b, an example of the user of a graphics dock 270 (which may comprise connectors such as USB 3, gigabit ethernet and a discrete graphics card with a High-Definition Multimedia Interface (HDMI) connector and/or a Video Graphics Array (VGA) interface) or a standalone (external) graphics card (which may be a 150-250 W discrete graphics card for premium gaming). A computing device, such as a laptop or (small form factor) desktop computer 280 may use the graphics dock 270 or standalone graphics card 275 to output a HDMI or DP signal to a monitor or television 290.

In Motherboard-down configurations, discrete graphics (DG) can be attached with a Host CPU based platform. The DG system on chip (SoC) can include an embedded security controller for authenticating/loading verified and/or signed firmware (FW), such as prior to device HW initialization. For example, the DG can include a SPI (Serial Peripheral Interface) flash, such as an 8 MB flash. The flash may store/keep firmware, such as firmware for an embedded security controller. The DG can be a heterogenous processor which has its own resources to manage the device initialization independently. The DG can be attached and/or communicatively coupled with a host CPU. The DG may be unable to operate on its own unless the host CPU itself is powered on.

There is an increasing use and number of heterogenous processors, like DGs, in computing systems. Heterogenous processors may have non-sharing and/or unshared I/O (Input/Output) subsystems. This can pose challenges for device manufacturers to design a more cost-effective solutions which also provides verified and improved boot.

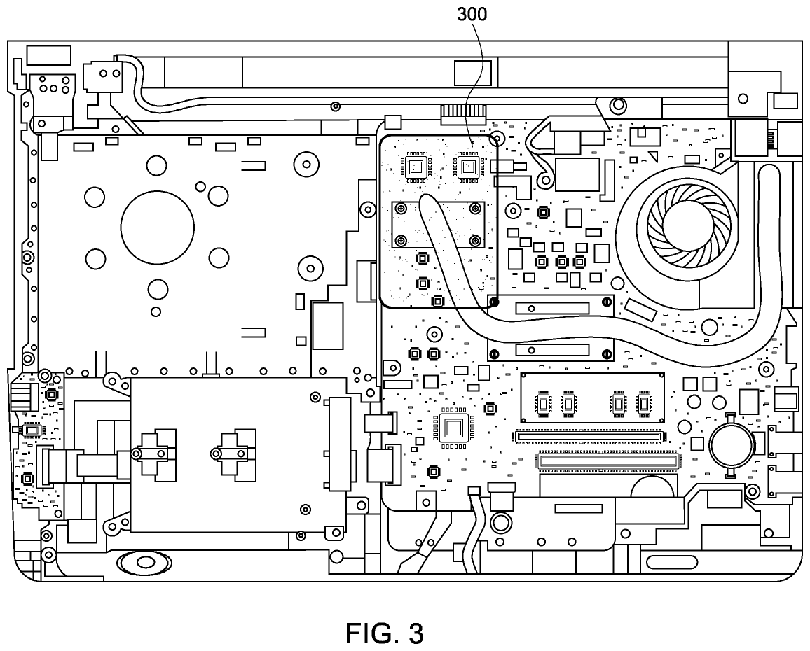

In an example, “Scenario-1,” DG is part of a Motherboard Down (MB) solution with a host CPU based platform as shown in FIG. 3. FIG. 3 shows a schematic diagram of a Discrete Graphics (DG) solution 300 that is soldered down to a motherboard of a laptop computer. Similarly, the SoC (System-on-Chip, which may include a CPU) and/or CPU may be part of the computing system. The SOC may be soldered to the MB. Herein is disclosed methods and apparatuses that can provide a symbiotic boot and/or methods and apparatuses where two or more heterogenous processors, XPUs, such as a CPU and a GPU, can possibly share their firmware, hardware, and/or software. Sharing such resources can improve boot performance, and/or reduce materials cost, for example.

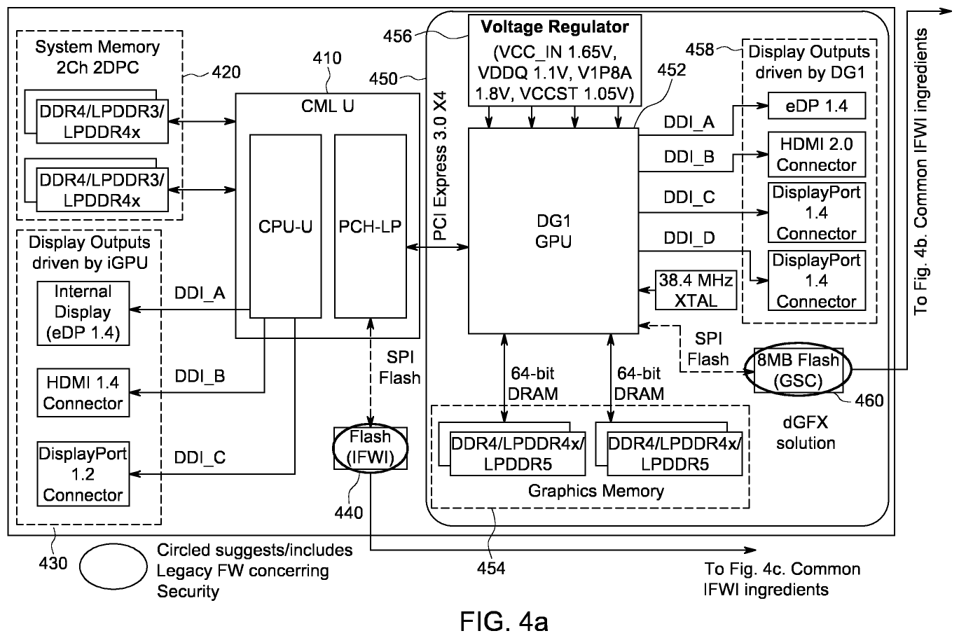

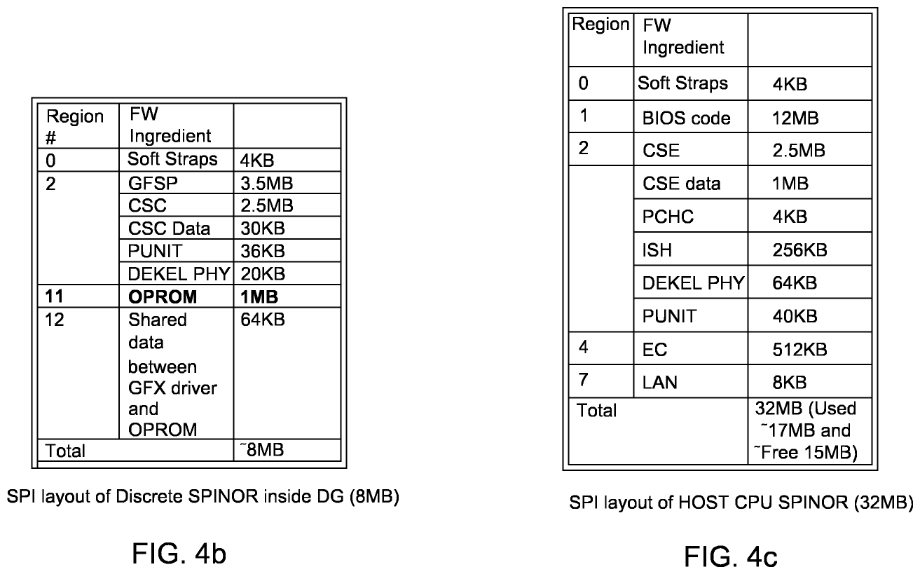

FIGS. 4a, 4b, and 4c illustrate the possibility of redundancy in platform design between host CPU and DG. The computing device shown in FIG. 4a comprises a CPU or SoC 410 with a CPU and a Platform Controller Hub (PCH). The CPU/SoC is coupled with a system memory 420. An integrated graphics solution of the CPU provides DDI signals to display outputs, such as for an internal display (e.g., via eDP), to a HDMI connector, or a DP connector. The PCHLP communicated with a flash memory device 440 for storing the IFWI (Integrated or Intel® Firm Ware Image). The computing device further comprises a DG solution 450, comprising a GPU 452, graphics memory 454, a voltage regulator 456 and display outputs 458 (eDP, HDMI, 2x DP) driven by the GPU. The DG solution 450 further comprises a flash memory device 460 (for storing the GSC firmware, Graphics Security Controller). For example, both CPU and DG can have its own dedicated memory (memory devices 440, 460) such as SPINOR (Serial Peripheral Interface NOR-based flash memory). The memory may store/keep firmware components, e.g., pre-reset firmware components. The FW (e.g., firmware image, or IFWI) can perform processor initialization. There can be overlap in the IFWI content that is in the respective memories (such as dedicated SPINORs) for the CPU and GPU initialization. For example, each heterogenous processor (XPU), such as the DPU and the GPU, may have a corresponding memory device which may store firmware for the associated XPU. It may be desirable to reduce redundancy and/or reduce the number of memory devices, such as by combining FW in a memory device that can be communicatively couplable to a plurality of XPUs. FIG. 4b shows the SPI layout of the discrete SPINOR 460 that is part of the DG 450. FIG. 4c shows the SPI layout of the host CPU SPINOR 440 (with approximately 17 MB used and 15 MB free according to an example).

For example, common hardware resources (e.g., a memory device such as SPINOR) can be used with a plurality of XPUs, e.g., in a platform with IA client SoC and DG. When multiple memory devices are used during the boot process, there can be duplication of IFWI and/or

IFWI components, which can result in higher platform BoM cost. Communalizing BoM components for motherboard-down platform might result in reduction of BOM cost.

In an example, duplication of firmware regions in memory devices for processors can occur. For example, a CPU SPINOR IFWI layout and DG IFWI layout may each include duplicate code and/or FW. For example, a platform with a CPU and DG may have about a total of MB (about 32 MB+about 8 MB) SPINOR memory. Such an example may have inefficient usage of system resources. For example, reusable IPs (Intellectual Property blocks, e.g., FW, coded instructions, and/or coded data) may be duplicated, for example in two memory devices (e.g., the 32 MB device and the 8 MB SPINOR).

A silicon or other type vendor may have a guideline to an original equipment manufacturer (OEM) and/or original design manufacturer (ODM) for a platform to have a minimum of 32 MB memory such as SPINOR. In practice, some memory may be unused, e.g., 10 MB or more of memory space remains unused. Unused memory space may be due at least in part to unaligned and/or uncertainty in the nature/amount of SPI usage. A platform design (like the DG motherboard down solution described above) may, according to examples, have sharable hardware resources, e.g., a shared memory device. If DG components are soldered down alongside the CPU in a client platform, then the root of trust may still be with a memory (e.g., SPINOR) attached with the SoC process controller hub (PCH), e.g., to enable verified SoC boot.

For example, in a mother board down configuration, a host computer can load a DiscreteGraphics Graphics Output Protocol Option/Operating Read-Only Memory (DG GOP OPROM), which may be the firmware for the second processing unit, e.g., via the BIOS. Loading the OPROM code may be associated with a pre-Operating System (OS) boot screen. OPROM can be getting executed outside of the SoC/CPU binary (e.g., outside of a Firmware Support Package (FSP) binary used for SoC initialization). Some problems that can be associated with such an example are as below. For example, redundant firmware/software block can initialize common hardware blocks for DG, which can increase development, integration, and validation work at the SoC provider side as well as the ODM/OEM side. System BIOS may need to support legacy OPROM. DG motherboard down IFWI may need to include video BIOS (VBIOS) OPROM. System BIOS may not be legacy free due to loading/executing legacy OPROM, and/or having a Compatibility Support Module (CSM) mode enabled. Option ROM for DG platform may run outside a trusted boundary (e.g., after post-boot SAI (Security Attribute of Initiator) enforcement).

Execution of OPROM can have several limitations, particularly with modern firmware solutions. For example, the UEFI (Unified Extensible Firmware Interface)/BIOS (Basic Input/Output System) can load and execute legacy firmware drivers like Legacy OPROM when a Compatibility Support Module (CSM) is enabled. When secure boot is enabled, execution of the Compatibility Support Module and legacy OPROMs may be prohibited, e.g., because legacy firmware drivers do not support authentication. CSM, when enabled, may allow UEFI to load legacy BIOS FW drivers. UEFI Secure Boot, when used properly and securely, may require each binary loaded at boot to be validated against known keys in the FW and/or identified by a cryptographic hash. Option ROM attacks can be considered as initial infection and/or to spread malicious code (e.g., firmware code) from one FW component (e.g., to another component and/or system). Compromising the Option ROM firmware by having an initial method of infection, may provide/allow a modification of the boot process, e.g., persistently. In such a scenario, the system firmware may not be modified. The infection may be more difficult to detect.

Herein, the lack of utilization of common hardware resources (i.e., dedicated SPINOR, dedicated security controller) between interoperable IA SoC offerings and DG even in motherboard-down mode may be considered a key disconnect in the evolution. For example, more than one, or up to all the processors of the system and/or mother board, during the boot process, may have duplicate IFWI components present. A higher platform BoM cost may result. Additionally, or alternatively, not having unified Hardware Abstract Layer (HAL, a program interface for accessing hardware) can result in redundant firmware, with a software solution eventually resulting in higher development cost and lack of unified verified boot.

Computing devices may include more and more heterogeneous computing devices (XPU, such as GPU, FPGA, AI etc.) due to increasing diverse computing need. Designing an XPU platform with heterogenous processors may eventually increase the redundancy in platform design for an example, multiple discrete SPINOR, dedicated security controller inside each heterogenous processor along with their firmware and/or software developing, maintenance cost.

Thus, there may be a desire for a concept for efficiently managing the hardware and firmware resources among heterogenous processors while designing a platform with Host CPU and DG, which may avoid redundancy in design with complex device solution, lesser interoperability even in symbiotic boot, higher BoM cost, possibly redundant firmware and software solutions for each heterogenous processors like CPU and DG, which may finally signify the wastage of resources and lack of unified verified boot in such platform.

In many systems, there is no such sharing model existed between host CPU and DGPU. Hence each heterogenous processor design has its own separate hardware resource, such as a SPINOR, without scope for optimization and resource utilization. As shown above, this may result into 32 MB SPINOR at CPU side and dedicated 8 MB SPINOR at discrete GPU even in motherboard down solutions, along with a separate security controller at each device to ensure firmware authentication and loading from SPINOR. This may lead to duplication of hardware resources like SPINOR and security controller among XPUs where majority of boot flow and security mechanism are aligned due to interoperable SoCs. The lack of sharing of these hardware resources may lead to an increased BOM, which could be avoided if the 8 MB SPINOR could be omitted. Moreover, at the firmware side, having dedicated firmware and software modules for each heterogenous processor may result into higher footprint and a prolonged boot process.

At the hardware side, both processors may share some common IPs like security controller, P_UNIT (a firmware unit), Display, GT (Graphics Technology), DEKEL (a physical layer implementation), NPK (North Peak), Gen 4 PCIe and the audio controller.

The proposed concept proposes to identify the common sharable resources between heterogenous processors in DG motherboard-down platforms, e.g., CPU and DG SoC (which may be the first and second processing unit introduced in connection with FIGS. 1a to 1c), to reduce dedicated hardware usage, which may help to reduce BoM cost and increase firmware, software reusage, e.g., using oneAPI library model. FIG. 5 shows a schematic diagram of an example of an architecture for firmware/software resource sharing, which may use an One-API library for firmware/software resource sharing. For example, the OS 510 may comprise an application 512 that interacts with a driver 514 (for accessing the respective XPU). The driver 514 may communicate, e.g., via the oneAPI Open Specification, with a Framework 522 that is part of the firmware 520. The Framework 522 may communicate with oneAPI Libraries 524. The oneAPI libraries 524 and a static initialization block 526 may communicate with the XPUs (CPU, GPU, FPGA, AI) via a hardware abstraction layer 528.

The proposed concept may provide methods that may enhance the platform performance through a symbiotic relationship between CPU and co-processor DG in an XPU platform, such as by reconfiguring the processor resources to share a common code and/or I/O interface during boot process with the co-processor for a verified boot. The code can come from a trusted source. As a possible first phase, the processor can share its hardware resource (e.g., flash interface, security controller etc.) with a discrete co-processor, e.g., for a symbiotic boot. As a possible subsequent phase, the boot firmware can be made configurable using oneAPI. A verified boot of the discrete co-processor can occur and can eliminate and/or reduce usage of redundant firmware in the co-processor by using the main processor boot code.

Herein are disclosed apparatuses and methods that can use a plurality of XPU's, including but not limited to GPUs, CPUs, VPUs, ASICS, FPGAs, AI chips, Habani AI ASICs, and spatial compute such as Altera FPGAs.

As efforts are made to encrypt and secure the FSP (Firmware Support Package), the encapsulation of XPU SI initialization e.g.by the FSP can be leveraged to protect the intellectual property, too. Also, as clients move to the Essential Security Engine (ESE) for a single point of silicon security in a SOC and/or server, and/or move to the Secure Startup Module (S3M), it may be possible to use ESE and S3M, respectively, as security offloads for the integrity and confidentiality of the XPU SI initialization in FSP. Apparatuses and methods described herein may provide cost advantages for ODM/OEMs, such as those who wish to design PCs with other processors like FPGA, GPU, or AI. At the firmware side, having unified firmware and software modules for processors, such as heterogenous processors, and/or heterogeneous computers, may result into smaller footprint and optimized verified boot process. Apparatuses and methods described herein may provide notebook platforms of greater interoperability and/or ensure better platform security compared to, for example, discrete processor solutions. Apparatuses and methods described herein may provide a legacy free platform design without running OPROM for discrete graphics initialization, which might nullify platform security risks potential due to OPROM. Apparatuses and methods described herein may provide a unified firmware flash layout between HOST CPU and DG to allow having in-field firmware update for DG motherboard-down solution.

The next paragraph may explain some hardware and firmware flow changes for the DG motherboard-down platform which may overcome the limitations mentioned above.

In the following, two phases are distinguished. In the first phase, with respect to SoC/hardware changes, a sharable SPINOR (e.g., the memory device introduced in connection with FIGS. 1a to 1c) solution between CPU and DG motherboard device is used. With respect to firmware changes, the master host CPU IFWI may be modified to accommodate slave heterogeneous processors of DG device firmware components. This phase may be more appropriate for a motherboard down design where DG components are soldered down, which nullifies the hot-plug use case. In a second phase, with respect to SoC/hardware changes, a unified firmware solution may be used between Host CPU and DG motherboard-down. With respect to firmware changes, the host CPU firmware, i.e., System BIOS (SBIOS), may be redesigned to initialize the DG device (SoC and HW components) independent of on-device Option ROM. A framework may be designed which can abstract the underlying DG hardware by providing oneAPI model for both firmware and software usage.

In the following, details are given with respect to phase 1 (shareable SPINOR solution between CPU and DG motherboard-down device). A flow is proposed that can help to design sharable SPINOR solution. For example, shared resource may be a beneficial approach where several independent entities can access their firmware/IFWI components from unified SPINOR.

In other systems, typically, a client platform with a consumer SKU (Store Keeping Unit) would use the SPI flash part attached with CPU-PCH (may be referred as Master from now onwards in this document), having a size of 32 MB. Other devices with processors, such as the DG and/or heterogeneous processors here (e.g., GPU, FPGA, AI) can be referred as Slave from now onwards in this document and may usually have a dedicated SPI flash of 8 MB size for its own embedded security firmware.

In the following, a “Master Attached Flash Sharing (MAF)” schema is provided, where a single SPI flash can be shared between master and slave device using a common SPI bus, as shown in FIG. 6. FIG. 6 shows a schematic diagram of an example of a computer device comprising a GPU 610 and a CPU 630, which use a shared SPI flash 620. For example, the GPU 610 may switch between using a dedicated DGPU flash (of size 8 MB) and the shared SPI flash 620. Both the dedicated DPGU flash 612 and the shared flash 620 may be accessed via a shared SPI interface 614. The CPU 630 may access the SPI flash 620 via an SPI interface 634 that is part of the PCH 632 of the CPU 630. In this design scheme, the slave device (e.g., the GPU 610) may not need its own/dedicated flash, instead possibly allowing G3 flash sharing support. Consequently, the dedicated flash of the DGPU may eventually be removed. For example, a single IFWI may be used for the entire DG motherboard-down platform and/or the dependency over dedicated SPI flash at the slave side may be removed. Master and slave can be each configured to use the SPI flash device accessed, e.g., via a bus.

FIG. 7 shows a schematic diagram of another example of a computer device comprising a DGPU 720 (with an enhanced SPI (eSPI) interface 722) and a CPU 710 (which may be part of a Multi-Chip Package), and which may have an eSPI interface 712 for communicating with the DGPU 720 and an SPI interface 714 communicate with the shared SPI flash 730. FIG. 7 illustrates the user of a shared SPI and eSPI (enhanced SPI) interface known as MAF (Master-Attached Flash). FIG. 7 shows the use of the MAF design schema, where flash components are attached to the eSPI master (the CPU in this case), which may be a separate chipset. The eSPI slave (the DGPU in this case) can access to the shared flash components through the flash access channel.

Run-time access to the flash component through the eSPI interface can go through the eSPI master, which may then route the cycle to the flash access block, before the cycle is getting forwarded to the SPI flash controller. Then, the SPI flash controller may perform the access to the SPI flash device on behalf of the eSPI slave. Flash access addresses used by the eSPI slaves may be physical flash linear addresses, which can cover up to the entire flash addressing space. The SPI flash controller 730 may impose access restriction of certain region order to ensure security.

Firmware Changes may be made. The hardware changes described herein, may include a single and shared SPI flash between master and slave device. At the firmware level, there may be master section descriptor changes, e.g., to accommodate a dedicated slave device firmware mapped into master SPI flash. A descriptor change may in some instances be inevitable to inject a slave device firmware region into IFWI layout on the SPINOR. For example, a dedicated/separate firmware region may be added for each XPU device as shown in FIG. 8. FIG. 8 shows a table of memory regions of an IFWI layout. For example, new firmware regions may be inserted into the existing IFWI layout. For example, region #13 may be used for GPU bring up firmware (which may hold CSC firmware, firmware patches and redundant images, region #14 may be used for FPGA and #15 for AI. The table of FIG. 8 is an illustrative example of firmware regions in memory. A memory can be a shared memory device (such as a SPINOR and/or SPI flash) that is used for two or more XPUs, particularly discrete XPUs, XPUs in a SOC, and/or XPUs in two or more dies on a motherboard. The memory may include regions reserved and/or accessible for each XPU.

During Boot, the master CPU firmware/BIOS may access the SPI flash using the SPI interface to boot and for the required initialization. FIG. 9 shows an example of a modified DG motherboard-down initialization flow. FIG. 9 illustrates a modified firmware boot flow of a system where MAF been implemented between CPU and DG. As shown in FIG. 9, the flow may involve the CPU 910, the SPI flash 920 and the GPU 930. For example, at 911, upon RESET #, the CPU may fetch the BIOS from the SPINOR 920. At 921, the BIOS may be provided by the SPI flash 920, and, at the CPU, the BIOS may start execution from flash memory region 2. Parallel to that, at 931, DG upon RESET #can start executing CSC ROM. Additionally, at 932, ROM code inside DG can fetch DG FW from master SPI flash Region #13 using MAF schema. At 912, the host CPU Firmware/BIOS can continue CPU and chipset register programming. Concurrently, at 933 DG FW can find pCode patch from SPINOR, authentication, and load pCode patch. Similarly, at 934, the same process for any other associated firmware like DEKEL PHY may occur. At 935, the GPU may request memory training using memory reference code (MRC) parameters. At 913, the CPU may probe PCI devices for enumeration and allocate Bus:Device:Function (B:D:F). The DG firmware can perform memory controller initialization before letting HOST CPU firmware/BIOS ask for device initialization. At this stage, the GPU device can be ready for any graphics related initialization, approximately ˜150 ms from DGPU RESET #. At 914, the CPU may perform graphics initialization if the GPU is present. At 936, the GPU may provide a graphics framebuffer for rendering. The BIOS can initiate GPU initialization using the unified approach. Once the GPU (graphics) is initialized, any output device (i.e., HDMI or DP, Display Port) over DG can be ready with resolution and allocated framebuffer for further display related usage. At 915, the CPU may display the pre-OS logo using the DGPU and boot to the OS and show the OS logo. For example, the BIOS or OS loader can render Pre-OS/OS splash screen using that framebuffer.

To improve platform security, “Region Access Control” may be applied. For example, as shown in FIG. 10, each flash region can be defined for read or write access by setting a protection parameter in the master section of the descriptor. FIG. 10 shows a table that illustrates region access control. For example, the descriptor region (0) may be read only for the CPU/BIOS, and not accessible for the DG. For example, the descriptor region may not be a master hence might not have master read/write access, or the descriptor may not have written access by any master. The BIOS region (1) may be accessible for the CPU/BIOS with read and write access prior to the end-of-post (EOP) message. The GPU firmware region (13) may be accessible for the CPU/BIOS and the DGPU with read and write access. For example, the CPU/BIOS may have GPU firmware write access as well to ensure FW update.

In the following, phase #2 is explained in more detail. In phase #2, a unified firmware solution may be used for the host CPU and the DG.

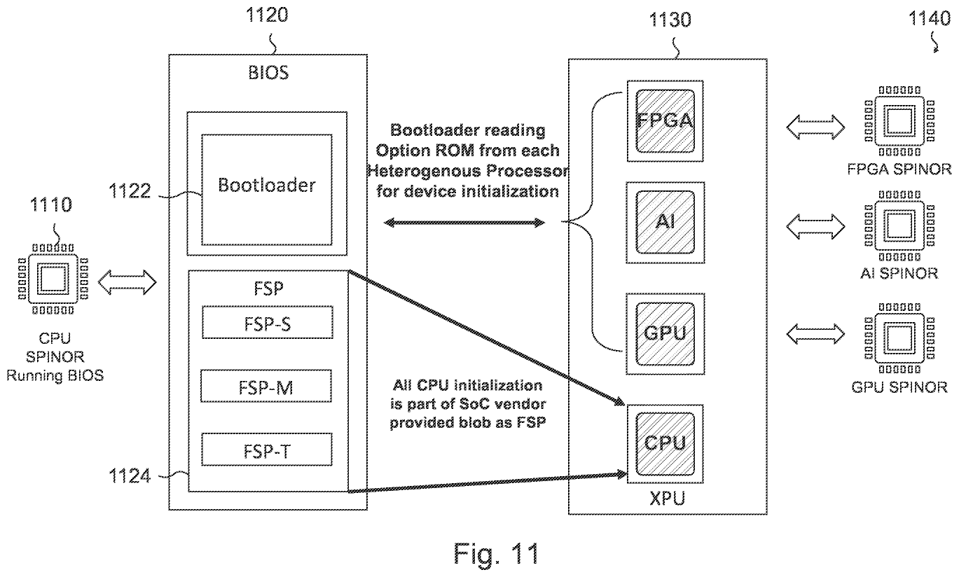

Modern system BIOS may comprise 2 key elements as SoC vendor provided silicon initialization code in a binary format, such as the Intel® Firmware Support Package (FSP) which is getting consumed by various open and/or closed source Bootloader implementations (e.g., tianocore.org, coreboot.org and slim bootloader) to distinguish as Production BIOS for ODM/OEM platform. In a platform with multiple heterogenous processors, where every other heterogenous processor has its own SPINOR comprising dedicated firmware blobs, which are getting executed outside the silicon initialization code (FSP) boundary, might pose a challenge as shown in FIG. 11. FIG. 11 shows the use of redundant firmware blobs for each heterogenous processor. As shown in FIG. 11, a CPU 1110 is shown, which is coupled to a SPINOR and which runs a BIOS 1120. Furthermore, firmware blobs 1130 and the SPINOR of the respective XPUs 1140 are shown. The BIOS 1120 comprises a bootloader 1122 and the FSP 1124, which comprises the components Firmware Support Package-Memory (FSP-M), Firmware Support Package-Silicon (FSP-S) and Firmware Support Package-Temporary RAM (FSP-T). The CPU initialization is part of the SoC vendor provided blob as FSP. The Bootloader 1122 reads the OPROM from each heterogeneous processor apart from the CPU (from the SPINOR 1130). Having dedicated FW blobs requirement for each processor may require a discrete HW block and may result in a higher BoM. In addition, allowing DG initialization code to run at bootloader context might not qualify as SoC verified boot. Executing Option ROM for each processor can result into higher boot time due to dependency over PCI enumeration, dynamic resource allocation before initializing the controller or device.

Herein are disclosed methods and apparatuses to extend the support of silicon reference block as FSP Firmware Support Package. The scope of the XPU initialization may be brought to use the FSP (instead of the bootloader, for example). For example, a hardware abstraction layer as described herein may be used so the SoC vendor recommended chipset programming is performed using a unified block.

Herein is disclosed an XPU platform (e.g., computing device) with a CPU and a GPU, where the FSP is designated to perform initialization of devices over GPU in symbiotic boot process by replacing the use of dedicated Option ROM. Other examples can be with other processors, including heterogeneous processors, as well with symbiotic boot.

FIG. 12 may illustrate a modified flow which may order to overcome limitations and design unified firmware for XPU platforms. FIG. 12 shows an example of a modified firmware boot flow with a unified firmware. FIG. 12 shows the use of FSP to initialize heterogeneous XPUs. FIG. 12 shows a unified IFWI layout 1210, comprising firmware blobs of up to all XPU firmware (in addition to the BIOS being used for the CPU). For example, the IFWI may comprise firmware blobs for GPU, FPGA and/or AI processing units. For example, some or all slave devices are using the unified SPINOR shared by the CPU using the MAF schema (master attached flash schema). A single SPI flash can be shared between master and slave device using common SPI bus as per FIG. 6. For example, region access control may be applied for product security, e.g., at the manufacturing phase. In FIG. 12, the FSP that is part of the BIOS 1230 manages the initialization of the CPU and of the other XPUs, using firmware blobs 1240 being provided by the respective SoC. For example, a modified master descriptor layout may be used to inject heterogenous processor specific bring up firmware blocks to ensure the other XPUs are ready for host CPU communication (e.g., as shown in FIG. 9). The BIOS is run by CPU 1220, which is coupled to the SPINOR comprising the IFWI. In the configuration shown in FIG. 12, the respective XPUs (FPGA, AI, GPU) do not require separate SPINORs 1250 comprising their respective firmware.

An example of a unified firmware support package is introduced in the following. For example, the bootloader may own the reset vector. A reset vector can be a default location a central processing unit will go to find the first instruction it will execute after a reset. The reset vector can be a pointer or address, where the CPU should always begin as soon as it is able to execute instructions. The bootloader may include the real mode reset vector handler code. Optionally, the bootloader can call FSP-T for CAR (Cache-as-RAM, Random Access Memory) setup and/or create stack Firmware Support Package. The bootloader can fill in required UPDs (Updatable Product Data) before calling FSP-M for memory initialization. On exit of FSP-M, the bootloader may tear down CAR and/or do the required silicon programming, including filling up UPDs for FSP-S, e.g., before calling FSP-S to initialize Chipset.

As XPUs, processors, and/or heterogeneous processors may be soldered down on a motherboard, e.g., using dedicated PCIe slots, the bootloader may not need to perform PCI enumeration and rather may rely on mainboard specific configuration to provide such PCIe slot information to the FSP. The bootloader may transfer call to invoke FSP-S. Control can reach an XPU Initialization sequence inside FSP-S. The FSP may add new UPDs to pass IA (IntelR Architecture) heterogenous processor attached PCIe slot information from the bootloader to the FSP blob. For example, the bootloader may pass the parameter IAXPUAddress, which is an array of 32-bit UPD parameters filled by the bootloader that can tell FSP about the address format of the XPU being attached with PCIe slot in form of bus, device, and function (B:D:F). Default value may be 0x0 and may identify as invalid address. Another parameter may be XPUConfigPtr, which is a 32-bit UPD parameter filled by the bootloader that can tell the FSP about the location of additional configuration data like Video BIOS Table (VBT) for the GPU. The default value may be NULL, and/or can identify as invalid address.

The format of IAXPUAddress may be the following: [Bus<<16|Device<<11|Function<<8| Offset (assume 0)]. In an example, if the bus number is 0xFE and device/function is 0, then the IAdGPUAddress (which may be the IAXPUAddress of the DGPU) UPD value could be 0x00FE0000.

For example, the following UPD variable definitions may be used inside FSP:
#!BSF NAME: {XPU PCI-E address format for FSP usage} TYPE: {EditNum, HEX, (0x00,0xFFFFFFFF)}
#!BSF HELP:{bootloader to tell FSP about address format of attached PCIE slot for FSP usage, Default value would be 0, identify as no device attached.}
gPlatformFspPkgTokenSpaceGuid. IAXPUAddress| *| 0x20| {0x00FE0000, 0x00, 0x00}
#!BSF NAME: {XPU Configuration Ptr}
#!BSF TYPE: {EditNum, HEX, (0x0,0xFFFFFFFF)}
#!BSF HELP:{Points to configuration data file like VBT}
gPlatformFspPkgTokenSpaceGuid.XPUConfigPtr| *| 0x04| 0x00000000

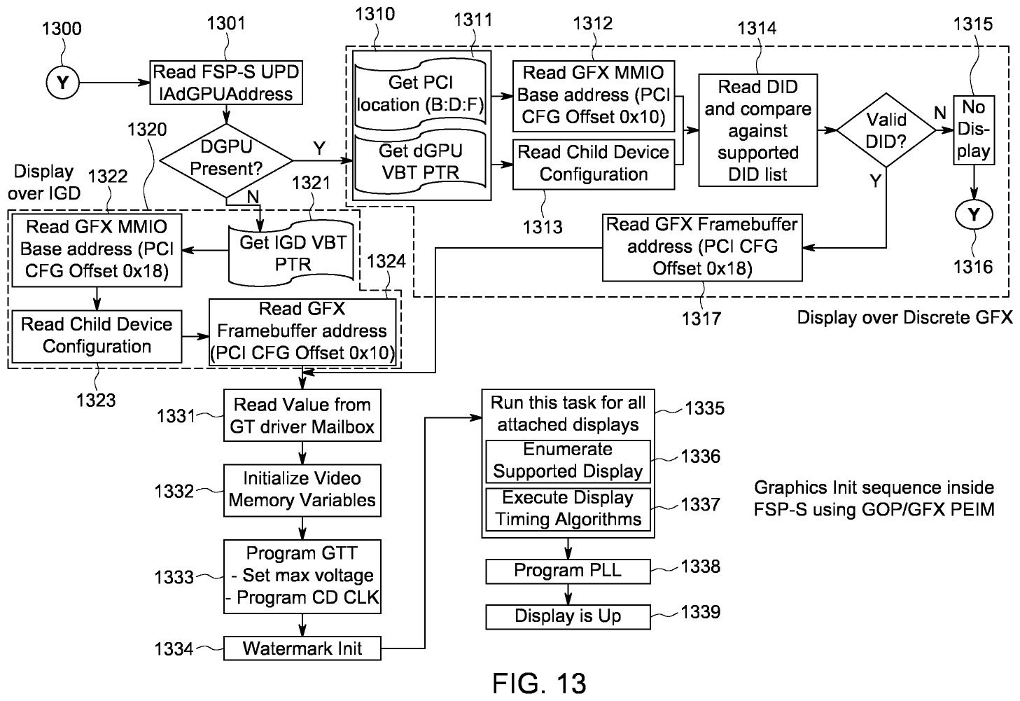

The VBT pointer UPD for GPU may be assigned after locating the vbt.bin binary from the flash RAW section. The bootloader may call FSP-S with IAXPUAddress overridden in order to initialize a display device over the discrete DGPU. The FSP-S may read UPD “IAXPUAddress” to know if the platform has any heterogenous processor attached as PCI-E device with a device location being provided in form of a B:D:F address. If the “IAXPUAddress”UPD value is greater than 0, it may mean that Dash-G is present. Then, the B:D: F information may be obtained from UPD. The XPU data configuration pointer may be read to know the configuration table presence like VBT. The FSP may identify the type of XPU that is associated with the PCI port and perform the respective call to initialize the device attached with the processor. An example with respect to a display attached to a GPU is given in FIG. 13. On exit of FSP-S, the display may get initialized for the device attached with the DGPU. The bootloader may perform PCI enumeration and resource allocation for all PCI/PCI-E device except the Dash-G device based on looking at Base Address Registers (BAR) and the MMIO/IO (Memory Mapped I/O) address space may be enabled. The FSP may create DGPU GFX ACPI (Advanced Configuration and Power Interface) OpRegion to pass VBT information for the GPU driver at the OS. The bootloader may call NotifyPhase at the proper stages before handing over to payload. The control may be transferred to the bootloader, and the bootloader may use the framebuffer to render any Pre OS logo, UEFI setup screen or OS splash screen.

FIG. 13 shows a flow chart of a unified FSP initialization flow with IGD (integrated graphics) and DGPU. The flow starts at 1300. At 1301, the FSP-S reads the IAdGPUAddress UPD. If a GDPU is present, the flow continues with block 1310 (display over discrete GFX/DGPU), if not, the flow continues with block 1320 (display over integrated graphics). In block 1310, at 1311, the PCI location (as B:D:F) and the dGPU VBT PTR (Pointer) are obtained. At 1312, the GFX MMIO base address is read (e.g., at PCI configuration offset 0x10). At 1313, the child device configuration is read. Based on the result of 1312 and 1313, the DID (Display Identifier) is read and compared with the list of supported DIDs. If the DID is invalid, at 1315, it is determined that no display is present, and the flow may end at 1316. If the DID is valid, at 1317, the GFX framebuffer address is read (e.g., at PCI configuration offset 0x18). In block 1320, at 1321, the IGD (integrated graphics) VBT PTR is obtained. At 1322, the GFX MMIO base address is read (e.g., at PCI configuration offset 0x18). At 1323, the child device configuration is read. At 1324, the GFX framebuffer address is read (e.g., at PCI configuration offset 0x10). From blocks 1317 and 1324, respectively the flow continues to 1331, where the value from the GT (Graphics Technology) driver mailbox is read. At 1332, the video memory variables are initialized. At 1333, the GTT (Graphics Translation Table) is programmed, by setting the maximal voltage and programming the CD (Core Display) clock. At 1334, the watermark is initialized. At 1335, which is run for all attached displays, the supported display is enumerated (1336) and the display timing algorithms are executed (1337). At 1338, the PLL (Phase-Locked Loop) is programmed. At 1339, the display is up. For example, the flow may be a graphics initialization sequence inside the FSP-S (e.g., performed by the FSP-S) using the GOP (Graphics Output Protocol)/GFX PEIM (Pre-EFI Initialization Module.

Phase #1 and #2 can be used together to reduce or eliminate the dependency on using multiple SPINOR at the XPU platform, e.g., when working on a MB down solution.

In some examples, the Intel® oneAPI library may be used for DG. For example, as shown in FIG. 5, the FSP can be designated to perform the initialization of XPU devices. The initialization sequence may be divided into two parts as shown below. For example, as a first part, a static DG initialization process may be performed (using the static initialization block 526) as part of boot services inside the FSP. As a second part, a oneAPI library function may be created for accessing the XPU hardware resources (as part of the oneAPI libraries 524). A set of library functions that may communicate with XPU hardware may be available, e.g., as part of the FSP runtime service. For example, different OS stacks 510 (such as Windows, Chrome, OS-X, Android) may not necessarily have to develop a dedicated OS driver 514 while communicating with the XPU hardware. A generic OS driver may be adequate, e.g., while using the runtime service framework, e.g., to pass a request from OS layer to firmware layer based on application 512 need. For example, the runtime oneAPI services can be part of FSP. For example, an ESE like security controller may be used for ensuring SoC root of trust in XPU initialization process as part of verified boot.

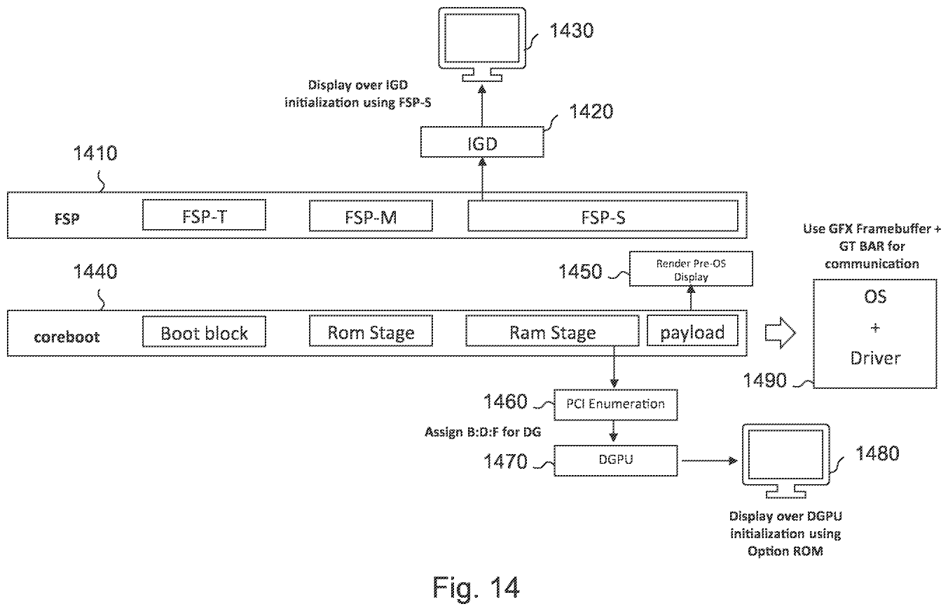

FIG. 14 illustrates an initialization flow, where the DGPU is initialized via coreboot. In FIG. 14, the FSP 1410 (including FSP-T, FSP-M, FSP-S) is shown, which is used to initialize the integrated graphics 1420 (IGD), for initialization of a display 1430 over IGD using FSP-S. In FIG. 14, the coreboot (a bootloader) component 1440 is also shown, comprising a boot block, a ROM stage, a RAM stage and a payload. The RAM stage is used to perform PCI enumeration 1460 and to assign B:D:F for GDPU 1470, for initialization of a display 1480 over GDPU using option ROM. The payload is used to render 1450 the pre-OS display. Afterwards, the GFX Framebuffer and GT BAR is used for communication with OS and driver 1490.

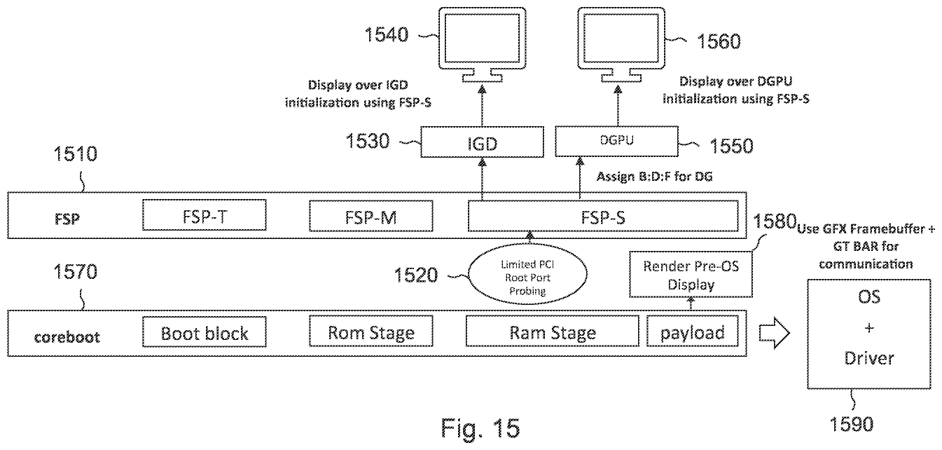

FIG. 15 illustrates an initialization flow, where the DGPU is initialized via FSP. FIG. 15 may illustrate an initialization flow such as One-API initialization flow for more than one XPU, such as a CPU and DGPU. In FIG. 15, the FSP 1510 (including FSP-T, FSP-M, FSP-S) is shown, with the FSP-S being used to initialize the IGD 1530, for initialization of a display 1540 over IGD using FSP-S, and with the FSP-S being used to initialize the DGPU 1550, for initialization of a display 1560 over DGPU using FSP-S. For this purpose, the FSP-S may perform limited PCI root port probing 1520. In this initialization flow, the payload of coreboot 1570 may render the pre-OS display 1580. However, the RAM stage might not be used to initialize the GDPU. Afterwards, the GFX Framebuffer and GT BAR is used for communication with OS and driver 1590.

Herein, an XPU may be a CPU, VPU, GPU, FPGA, ASIC, or programmable digital signal processor (DSP). Alternatively, or additionally, an XPU may be a heterogeneous processor.

More details and aspects of the method, system, and apparatus for DG symbiotic boot are mentioned in connection with the proposed concept or one or more examples described above or below (e.g., FIG. 1a to 1c). The method, system, and apparatus for DG symbiotic boot may comprise one or more additional optional features corresponding to one or more aspects of the proposed concept, or one or more examples described above or below.

In the following, some examples are presented:

An example (e.g., example 1) relates to a computing device (100) comprising a memory device (30), configured to store firmware for at least a first processing unit and a second processing unit. The computing device (100) comprises the first processing unit (10), configured to obtain the firmware for the first processing unit from the memory device, and to initialize itself using the firmware obtained from the memory device. The computing device (100) comprises the second processing unit (20), configured to obtain the firmware for the second processing unit from the memory device, and to initialize itself using the firmware obtained from the memory device.

Another example (e.g., example 2) relates to a previously described example (e.g., example 1) or to any of the examples described herein, further comprising that the first and second processing unit are configured to obtain the respective firmware from the same memory device.

Another example (e.g., example 3) relates to a previously described example (e.g., one of the examples 1 to 2) or to any of the examples described herein, further comprising that the first processing unit is a central processing unit, and the second processing unit is one of a graphics processing unit, a field-programmable gate array, a vision processing unit, and an artificial intelligence accelerator.

Another example (e.g., example 4) relates to a previously described example (e.g., one of the examples 1 to 3) or to any of the examples described herein, further comprising that the memory device comprises a first storage region with the firmware for the first processing unit and a separate second storage region with the firmware for the second processing unit.

Another example (e.g., example 5) relates to a previously described example (e.g., example 4) or to any of the examples described herein, further comprising that the memory device is a memory device associated with the first processing unit, with the memory device additionally comprising the separate second storage region with the firmware for the second processing unit.

Another example (e.g., example 6) relates to a previously described example (e.g., example 5) or to any of the examples described herein, further comprising that the memory device additionally comprise a separate third storage region comprising firmware for a third processing unit.

Another example (e.g., example 7) relates to a previously described example (e.g., one of the examples 5 to 6) or to any of the examples described herein, further comprising that the memory device is configured to provide access to the first and second storage region such, that access by the second processing unit is limited to the second storage region.

Another example (e.g., example 8) relates to a previously described example (e.g., one of the examples 1 to 7) or to any of the examples described herein, further comprising that the memory device comprises a shared region which includes codes for operating at least part of the first processing unit and at least part of the second processing unit.

Another example (e.g., example 9) relates to a previously described example (e.g., one of the examples 1 to 8) or to any of the examples described herein, further comprising that the firmware for at least the second processing unit comprises a device-specific portion and a device-agnostic portion, with the device-agnostic portion being configured to access the respective processing unit via a hardware abstraction layer being part of the device-specific portion.

Another example (e.g., example 10) relates to a previously described example (e.g., example 9) or to any of the examples described herein, further comprising that the device-specific portion comprises a device-specific static initialization portion.

Another example (e.g., example 11) relates to a previously described example (e.g., example 10) or to any of the examples described herein, further comprising that the second processing unit is configured to use the device-specific static initialization portion to initialize itself to the point of communication with the first processing unit, and to continue initialization using the device-agnostic portion with help of the first processing unit.

Another example (e.g., example 12) relates to a previously described example (e.g., one of the examples 1 to 11) or to any of the examples described herein, further comprising that the first and second processing unit are configured to share one or more shared components of the computing device during a secure initialization procedure of the computing device, the one or more shared components comprising the memory device.

Another example (e.g., example 13) relates to a previously described example (e.g., example 12) or to any of the examples described herein, further comprising that the one or more shared components comprise at least one of security controller circuitry and flash controller circuitry.

Another example (e.g., example 14) relates to a previously described example (e.g., one of the examples 12 to 13) or to any of the examples described herein, further comprising that at least one of the first processing unit and the second processing unit is configured to access the memory device via a master-attached flash sharing scheme.

Another example (e.g., example 15) relates to a previously described example (e.g., one of the examples 1 to 14) or to any of the examples described herein, further comprising that the memory device is a flash-based memory device that is configured to communicate with the first and second processing unit via a serial peripheral interface.

Another example (e.g., example 16) relates to a previously described example (e.g., one of the examples 1 to 15) or to any of the examples described herein, further comprising that at least one of the first and the second processing unit is a soldered-down processing unit.

Another example (e.g., example 17) relates to a previously described example (e.g., one of the examples 1 to 16) or to any of the examples described herein, further comprising that the computing device comprises a motherboard, with at least one of the first and the second processing unit being soldered to the motherboard.

An example (e.g., example 18) relates to a computing device (100) comprising a means for storing information (30), configured to store firmware for at least a first means for processing and a second means for processing. The computing device (100) comprises the first means for processing (10), configured to obtain the firmware for the first means for processing from the means for storing information, and to initialize itself using the firmware obtained from the means for storing information. The computing device (100) comprises the second means for processing (20), configured to obtain the firmware for the second means for processing from the means for storing information, and to initialize itself using the firmware obtained from the means for storing information.

Another example (e.g., example 19) relates to a previously described example (e.g., example 18) or to any of the examples described herein, further comprising that the first and second means for processing are configured to obtain the respective firmware from the same means for storing information.

Another example (e.g., example 20) relates to a previously described example (e.g., one of the examples 18 to 19) or to any of the examples described herein, further comprising that the first means for processing is a central means for processing, and the second means for processing is one of a graphics means for processing, a field-programmable gate array, a vision means for processing, and an artificial intelligence accelerator.

Another example (e.g., example 21) relates to a previously described example (e.g., one of the examples 18 to 20) or to any of the examples described herein, further comprising that the means for storing information comprises a first storage region with the firmware for the first means for processing and a separate second storage region with the firmware for the second means for processing.

Another example (e.g., example 22) relates to a previously described example (e.g., example 21) or to any of the examples described herein, further comprising that the means for storing information is a means for storing information associated with the first means for processing, with the means for storing information additionally comprising the separate second storage region with the firmware for the second means for processing.

Another example (e.g., example 23) relates to a previously described example (e.g., example 22) or to any of the examples described herein, further comprising that the means for storing information additionally comprise a separate third storage region comprising firmware for a third means for processing.

Another example (e.g., example 24) relates to a previously described example (e.g., one of the examples 22 to 23) or to any of the examples described herein, further comprising that the means for storing information is configured to provide access to the first and second storage region such, that access by the second means for processing is limited to the second storage region.

Another example (e.g., example 25) relates to a previously described example (e.g., one of the examples 19 to 24) or to any of the examples described herein, further comprising that the means for storing information comprises a shared region which includes codes for operating at least part of the first means for processing and at least part of the second means for processing.

Another example (e.g., example 26) relates to a previously described example (e.g., one of the examples 19 to 25) or to any of the examples described herein, further comprising that the firmware for at least the second means for processing comprises a device-specific portion and a device-agnostic portion, with the device-agnostic portion being configured to access the respective means for processing via a hardware abstraction layer being part of the device-specific portion.

Another example (e.g., example 27) relates to a previously described example (e.g., example 26) or to any of the examples described herein, further comprising that the device-specific portion comprises a device-specific static initialization portion.

Another example (e.g., example 28) relates to a previously described example (e.g., example 27) or to any of the examples described herein, further comprising that the second means for processing is configured to use the device-specific static initialization portion to initialize itself to the point of communication with the first means for processing, and to continue initialization using the device-agnostic portion with help of the first means for processing.

Another example (e.g., example 29) relates to a previously described example (e.g., one of the examples 18 to 28) or to any of the examples described herein, further comprising that the first and second means for processing are configured to share one or more shared components of the computing device during a secure initialization procedure of the computing device, the one or more shared components comprising the means for storing information.

Another example (e.g., example 30) relates to a previously described example (e.g., example 29) or to any of the examples described herein, further comprising that the one or more shared components comprise at least one of security controller circuitry and flash controller circuitry.

Another example (e.g., example 31) relates to a previously described example (e.g., one of the examples 29 to 30) or to any of the examples described herein, further comprising that at least one of the first means for processing and the second means for processing is configured to access the means for storing information via a master-attached flash sharing scheme.

Another example (e.g., example 32) relates to a previously described example (e.g., one of the examples 18 to 31) or to any of the examples described herein, further comprising that the means for storing information is a flash-based means for storing information that is configured to communicate with the first and second means for processing via a serial peripheral interface.

Another example (e.g., example 33) relates to a previously described example (e.g., one of the examples 18 to 32) or to any of the examples described herein, further comprising that at least one of the first and the second means for processing is a soldered-down means for processing.

Another example (e.g., example 34) relates to a previously described example (e.g., one of the examples 18 to 33) or to any of the examples described herein, further comprising that the computing device comprises a motherboard, with at least one of the first and the second means for processing being soldered to the motherboard.

An example (e.g., example 35) relates to a method for initializing a computing device, the method comprising obtaining (130) a firmware for a first processing unit from a memory device. The method comprises obtaining (140) a firmware for a second processing unit from the same memory device. The method comprises initializing (150; 160) the first and the second processing unit using the respective firmware obtained from the memory device.

Another example (e.g., example 36) relates to a previously described example (e.g., example 35) or to any of the examples described herein, further comprising that the first and second processing unit obtain the respective firmware from the same memory device.

Another example (e.g., example 37) relates to a previously described example (e.g., one of the examples 35 to 36) or to any of the examples described herein, further comprising that the first processing unit is a central processing unit, and the second processing unit is one of a graphics processing unit, a field-programmable gate array, a vision processing unit, and an artificial intelligence accelerator.

Another example (e.g., example 38) relates to a previously described example (e.g., one of the examples 35 to 37) or to any of the examples described herein, further comprising that the memory device comprises a first storage region with the firmware for the first processing unit and a separate second storage region with the firmware for the second processing unit.

Another example (e.g., example 39) relates to a previously described example (e.g., example 38) or to any of the examples described herein, further comprising that the memory device is a memory device associated with the first processing unit, with the memory device additionally comprising the separate second storage region with the firmware for the second processing unit.

Another example (e.g., example 40) relates to a previously described example (e.g., example 39) or to any of the examples described herein, further comprising that the memory device additionally comprise a separate third storage region comprising firmware for a third processing unit.

Another example (e.g., example 41) relates to a previously described example (e.g., one of the examples 39 to 40) or to any of the examples described herein, further comprising that the memory device provides (110) access to the first and second storage region such, that access by the second processing unit is limited to the second storage region.

Another example (e.g., example 42) relates to a previously described example (e.g., one of the examples 35 to 41) or to any of the examples described herein, further comprising that the memory device comprises a shared region which includes codes for operating at least part of the first processing unit and at least part of the second processing unit.

Another example (e.g., example 43) relates to a previously described example (e.g., one of the examples 35 to 42) or to any of the examples described herein, further comprising that the firmware for at least the second processing unit comprises a device-specific portion and a device-agnostic portion, with the device-agnostic portion being configured to access the respective processing unit via a hardware abstraction layer being part of the device-specific portion.

Another example (e.g., example 44) relates to a previously described example (e.g., example 43) or to any of the examples described herein, further comprising that the device-specific portion comprises a device-specific static initialization portion.

Another example (e.g., example 45) relates to a previously described example (e.g., example 44) or to any of the examples described herein, further comprising that the method comprises, by the second processing unit, using (162) the device-specific static initialization portion to initialize itself to the point of communication with the first processing unit, and continuing (164) initialization using the device-agnostic portion with help of the first processing unit.

Another example (e.g., example 46) relates to a previously described example (e.g., one of the examples 35 to 45) or to any of the examples described herein, further comprising that the method comprises sharing (120), by the first and second processing unit one or more shared components of the computing device during a secure initialization procedure of the computing device, the one or more shared components comprising the memory device.

Another example (e.g., example 47) relates to a previously described example (e.g., example 46) or to any of the examples described herein, further comprising that the one or more shared components comprise at least one of security controller circuitry and flash controller circuitry.

Another example (e.g., example 48) relates to a previously described example (e.g., one of the examples 46 to 47) or to any of the examples described herein, further comprising that at least one of the first processing unit and the second processing unit accesses the memory device via a master-attached flash sharing scheme.

Another example (e.g., example 49) relates to a previously described example (e.g., one of the examples 35 to 48) or to any of the examples described herein, further comprising that the memory device is a flash-based memory device that communicates with the first and second processing unit via a serial peripheral interface.

Another example (e.g., example 50) relates to a previously described example (e.g., one of the examples 35 to 49) or to any of the examples described herein, further comprising that at least one of the first and the second processing unit is a soldered-down processing unit.

Another example (e.g., example 51) relates to a previously described example (e.g., one of the examples 35 to 50) or to any of the examples described herein, further comprising that the computing device comprises a motherboard, with at least one of the first and the second processing unit being soldered to the motherboard.

An example (e.g., example 52) relates to a non-transitory machine-readable storage medium including program code, when executed, to cause a machine to perform the method of one of the examples 35 to 51 or according to any other example.

An example (e.g., example 53) relates to a computer program having a program code for performing the method of one of the examples 35 to 51 or according to any other example when the computer program is executed on a computer, a processor, or a programmable hardware component.

An example (e.g., example 54) relates to a machine-readable storage including machine readable instructions, when executed, to implement a method or realize an apparatus as claimed in any pending claim or shown in any example.

An example (e.g., example A1) relates to a memory device, comprising a plurality of regions which each include firmware configured to boot, initialize, and/or operate a plurality of XPUs.

In another example (e.g., example A2), the subject-matter of a previous example (e.g., example A1) or any other example may further comprise, that the memory device is in a single die which may optionally include at least one of the XPUs.

In another example (e.g., example A2.1), the subject-matter of a previous example (e.g., example A1 or A2) or any other example may further comprise, that the plurality of regions includes a first region and a second region, wherein the first region is configured for initializing a first XPU, and the second region is configured for initializing a second XPU; wherein optionally the first XPU is selected from a list comprising: a CPU, a GPU (DGPU), a FPGA, a VPU, and an AI processing unit; and the second XPU is selected from a list comprising: a CPU, a GPU (DGPU), a FPGA, a VPU, and an AI processing unit.

In another example (e.g., example A2.2), the subject-matter of a previous example (e.g., one of examples A1 to A2.1) or any other example may further comprise, that the plurality of regions includes a common region, wherein the common region is configured for operation of the first XPU and the second XPU, particularly after initialization of the first and second XPUs, such as after an operating system is loaded and/or acting as host. For example, the plurality of regions may include those for initialization which are configured to initialize exactly one XPU.

In another example (e.g., example A2.3), the subject-matter of a previous example (e.g., one of examples A1 to A2.2) or any other example may further comprise, that the memory device is programmable nonvolatile memory.

In another example (e.g., example A3), the subject-matter of a previous example (e.g., one of examples A1 to A2.3) or any other example may further comprise, that the plurality of XPUs are selectable from a list comprising: a CPU, a GPU, (DGPU, a FPGA, a VPU, an AI processing unit, a heterogeneous processor, and combinations thereof.

In another example (e.g., example A4), the subject-matter of a previous example (e.g., one of examples A1 to A3) or any other example may further comprise, that the memory device is configured to be communicatively coupled to the plurality of XPUs; wherein optionally the memory device is configured such that each region is communicatively couplable to a respective XPU of the plurality of XPUs; wherein optionally each region is configured to be uniquely and/or exclusively communicatively couplable to the respective XPUs for initialization.

In another example (e.g., example A5), the subject-matter of a previous example (e.g., one of examples A1 to A4) or any other example may further comprise, that the device utilizes NOR memory.

In another example (e.g., example A6), the subject-matter of a previous example (e.g., one of examples A1 to A5) or any other example may further comprise, that the device is configured to be accessible by a serial peripheral interface; wherein optionally the regions are configured to be accessible by the serial peripheral interface.

In another example (e.g., example A7), the subject-matter of a previous example (e.g., one of examples A1 to A6) or any other example may further comprise, that the device is a flash memory device.

In another example (e.g., example A8), the subject-matter of a previous example (e.g., one of examples A1 to A7) or any other example may further comprise, that at least one of the regions are configured to be accessed by a master processor which may be one of the XPUs.

In another example (e.g., example A8), the subject-matter of a previous example (e.g., one of examples A1 to A8, e.g., one of the examples A2.1 to 8) or any other example may further comprise, that the device is configured to initialize the first and second XPUs; and wherein the device further includes a shared region which includes code for operating at least part of the first XPU and at least part of the second XPU.

An example (e.g., example A10) relates to a device, comprising a first XPU, and a second XPU, wherein the first and second XPU are each configured to access a memory device, such as the memory device of any one of the above examples (e.g., examples A1 to A9).

In another example (e.g., example A11), the subject-matter of a previous example (e.g., example A10) or any other example may further comprise, that the first XPU is configured to access a first firmware in the memory device, such as in a first region of the memory device.

In another example (e.g., example A12), the subject-matter of a previous example (e.g., one of examples A10 to A11) or any other example may further comprise, that the second XPU is configured as a slave to the first XPU.

In another example (e.g., example A13), the subject-matter of a previous example (e.g., one of examples A10 to A12) or any other example may further comprise, that the second XPU is communicatively coupled to the memory device through the first XPU.

In another example (e.g., example A14), the subject-matter of a previous example (e.g., one of examples A10 to A13) or any other example may further comprise a first die including the first processor, and a second die including the second processor; and optionally further comprising a third die which includes the memory device.

An example (e.g., example A15) relates to a computer system including the device of any preceding example (e.g., one of the examples A10 to 14) or any other example.

An example (e.g., example A16) relates to a method of booting, initializing, and/or operating a plurality of XPUs, comprising accessing code from each of the plurality of regions of the memory device of any of the above examples (e.g., of one of the examples A1 to A9), and booting and/or initializing a first and second XPU based on corresponding first and second regions of the memory device.

An example (e.g., example A17) relates to a non-transitory computer readable medium comprising code for executing the above method (e.g., the method of example A16).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A computing device comprising:
a memory device, configured to store firmware for at least a first processing unit and a second processing unit;
the first processing unit, configured to obtain the firmware for the first processing unit from the memory device, and to initialize itself using the firmware obtained from the memory device;
the second processing unit, configured to obtain the firmware for the second processing unit from the memory device, and to initialize itself using the firmware obtained from the memory device.

2. The computing device according to claim 1, wherein the first and second processing unit are configured to obtain the respective firmware from the same memory device.

3. The computing device according to claim 1, wherein the first processing unit is a central processing unit, and the second processing unit is one of a graphics processing unit, a field-programmable gate array, a vision processing unit, and an artificial intelligence accelerator.

4. The computing device according to claim 1, wherein the memory device comprises a first storage region with the firmware for the first processing unit and a separate second storage region with the firmware for the second processing unit.

5. The computing device according to claim 4, wherein the memory device is a memory device associated with the first processing unit, with the memory device additionally comprising the separate second storage region with the firmware for the second processing unit.

6. The computing device according to claim 5, wherein the memory device additionally comprise a separate third storage region comprising firmware for a third processing unit.

7. The computing device according to claim 5, wherein the memory device is configured to provide access to the first and second storage region such, that access by the second processing unit is limited to the second storage region.

8. The computing device according to claim 1, wherein the memory device comprises a shared region which includes codes for operating at least part of the first processing unit and at least part of the second processing unit.

9. The computing device according to claim 1, wherein the firmware for at least the second processing unit comprises a device-specific portion and a device-agnostic portion, with the device-agnostic portion being configured to access the respective processing unit via a hardware abstraction layer being part of the device-specific portion.

10. The computing device according to claim 9, wherein the device-specific portion comprises a device-specific static initialization portion.

11. The computing device according to claim 10, wherein the second processing unit is configured to use the device-specific static initialization portion to initialize itself to the point of communication with the first processing unit, and to continue initialization using the device-agnostic portion with help of the first processing unit.

12. The computing device according to claim 1, wherein the first and second processing unit are configured to share one or more shared components of the computing device during a secure initialization procedure of the computing device, the one or more shared components comprising the memory device.

13. The computing device according to claim 12, wherein the one or more shared components comprise at least one of security controller circuitry and flash controller circuitry.

14. The computing device according to claim 12, wherein at least one of the first processing unit and the second processing unit is configured to access the memory device via a master-attached flash sharing scheme.

15. The computing device according to claim 1, wherein the memory device is a flash-based memory device that is configured to communicate with the first and second processing unit via a serial peripheral interface.

16. The computing device according to claim 1, wherein at least one of the first and the second processing unit is a soldered-down processing unit.

17. (canceled)

18. A computing device comprising:
a means for storing information, configured to store firmware for at least a first means for processing and a second means for processing;
the first means for processing, configured to obtain the firmware for the first means for processing from the means for storing information, and to initialize itself using the firmware obtained from the means for storing information;
the second means for processing, configured to obtain the firmware for the second means for processing from the means for storing information, and to initialize itself using the firmware obtained from the means for storing information.

19. The computing device according to claim 18, wherein the first and second means for processing are configured to obtain the respective firmware from the same means for storing information.

20. A method for initializing a computing device, the method comprising:
obtaining a firmware for a first processing unit from a memory device;
obtaining a firmware for a second processing unit from the same memory device; and
initializing the first and the second processing unit using the respective firmware obtained from the memory device.

21. A non-transitory, computer-readable medium a program code for performing the method of claim 20, when the computer program is executed on a computer, a processor, or a programmable hardware component.
